(19) United States
(12) Patent Application Publication
(10) Pub. No.: US 2005/0192080 A1
(43) Pub. Date: Sep. 1, 2005

(54) Method of playing a game with bonus payout using a replacement feature

(76) Inventors: Louise Cote, Magog (CA); Ghislain Dore, Drummondville (CA)

Correspondence Address: LABTRONIX CONCEPT INC.;C/O OGILVY RENAULT, 1981 MC GILL COLLEGE AVENUE, SUITE 1600, MONTREAL, QUEBEC, H3A 2Y3, CA

(21) Appl. No.: 11/036,209

(22) Filed: Jan. 18, 2005

Related U.S. Application Data
(60) Provisional application No. 60/536,512, filed on Jan. 15, 2004.

(51) Int. Cl. G06F 17/00; G06F 19/00; A63F 9/24

(52) U.S. Cl. 463/17; 463/20

(57) ABSTRACT

This invention provides a method of playing a game comprising: providing a game outcome comprising a plurality of game indicia selected from a first set of game indicia; evaluating said game outcome according to game rules and determining whether said game outcome comprises a triggering outcome. Upon occurrence of a positive determination, the method also comprises: replacing one or more game indicia of the game outcome with one or more replacement game indicia selected from a second set of game indicia; determining at least one replacement outcome based at least in part on said one or more replacement game indicia; and evaluating each of said at least one replacement outcome according to replacement game rules, and wherein at least one of the following is true: the first set of game indicia is not identical to the second set of game indicia; and the game rules are not identical to the replacement game rules.

### CROSS-REFERENCE TO RELATED APPLICATIONS

This application claims priority under 35USC§119(e) of U.S. provisional patent application 60/536,512 filed Jan. 15th, 2004, the specification of which is hereby incorporated by reference.

### TECHNICAL FIELD

The present invention relates to a game using a replacement feature.

### BACKGROUND OF THE INVENTION

Gambling has evolved a lot during the last few years, and game manufacturers are always searching for new methods to interest and entertain players. Players are always demanding more features and payout schemes.

Improvements in these kinds of games are desired to enhance the player's interest and entertainment.

### SUMMARY OF THE INVENTION

In accordance with an embodiment of the present invention, there is provided a method of playing a game comprising: providing a game outcome comprising a plurality of game indicia selected from a first set of game indicia; evaluating said game outcome according to game rules and determining whether said game outcome comprises a triggering outcome. Upon occurrence of a positive determination, the method also comprises: replacing one or more game indicia of the game outcome with one or more replacement game indicia selected from a second set of game indicia; determining at least one replacement outcome based at least in part on said one or more replacement game indicia; and evaluating each of said at least one replacement outcome according to replacement game rules, and wherein at least one of the following is true: the first set of game indicia is not identical to the second set of game indicia; and the game rules are not identical to the replacement game rules.

In accordance with another embodiment of the present invention, there is provided a game apparatus comprising: a display means to display a game outcome comprising a plurality of game indicia selected from a first set of game indicia; evaluating means to evaluate the game outcome according to game rules and at least one replacement outcome according to replacement game rules; determination means to determine whether the game outcome comprises a triggering outcome, and determining at least one replacement outcome based, at least in part, on one or more replacement indicia; and replacement means to replace said game indicia with said one or more replacement game indicia selected from a second set of game indicia. Wherein at least one of the following is true: a)said first set of game indicia and second set of game indicia are not identical; and b)said game rules and said replacement game rules are not identical.

In accordance to another embodiment of the present invention, there is provided a computer program embodied on a computer readable medium or in processor-readable memory having codes adapted to: provide a game outcome comprising a plurality of game indicia selected from a first set of game indicia; evaluate said game outcome according to game rules; determine whether said game outcome comprises a triggering outcome; upon occurrence of a positive triggering outcome determination, replace one or more game indicia of the game outcome with one or more replacement game indicia selected from a second set of game indicia; determine at least one replacement outcome based at least in part on said one or more replacement game indicia; and evaluate each of said at least one replacement outcome according to replacement game rules, and wherein at least one of the following is true: a) said first set of game indicia and said second set of game indicia are not identical and b) said game rules and said replacement game rules are not identical.

In accordance to another embodiment of the present invention, there is provided a computer program carried on an electrical or electromagnetic carrier signal having codes adapted to: provide a game outcome comprising a plurality of game indicia selected from a first set of game indicia; evaluate said game outcome according to game rules; determine whether said game outcome comprises a triggering outcome; upon occurrence of a positive triggering outcome determination, replace one or more game indicia of the game outcome with one or more replacement game indicia selected from a second set of game indicia; determine at least one replacement outcome based at least in part on said one or more replacement game indicia; and evaluate each of said at least one replacement outcome according to replacement game rules, and wherein at least one of the following is true: a) said first set of game indicia and said second set of game indicia are not identical and b) said game rules and said replacement game rules are not identical.

### BRIEF DESCRIPTION OF THE DRAWINGS

Further features and advantages of the present invention will become apparent from the following detailed description, taken in combination with the appended drawings, in which:

FIG. 1 is a schematic diagram showing a perspective view of a gaming machine suitable for the present invention;

FIG. 2 is a bloc diagram illustrating the components of the gaming machine of FIG. 1;

FIG. 3 is a flowchart illustrating the steps of a simple embodiment of the present invention as played on the gaming machine of FIGS. 1 and 2;

FIGS. 4a and 4b are screen shots of a second embodiment of the present invention;

FIGS. 5a and 5b are screen shots of a game indicia/replacement game indicia collaboration game according to another embodiment of the present invention;

FIG. 6 is a screen shot of a replacement game indicia collaboration game according to another embodiment of the present invention; and

FIG. 7 is a screen shot of an individual replacement game indicia game according to another embodiment of the present invention.

It will be noted that throughout the appended drawings, like features are identified by like reference numerals.

### DETAILED DESCRIPTION OF THE PREFERRED EMBODIMENT

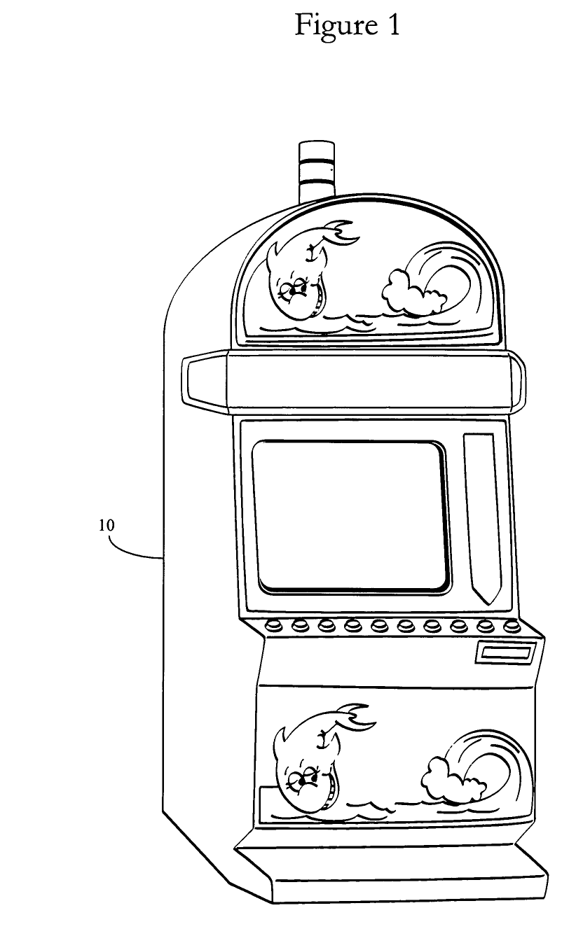

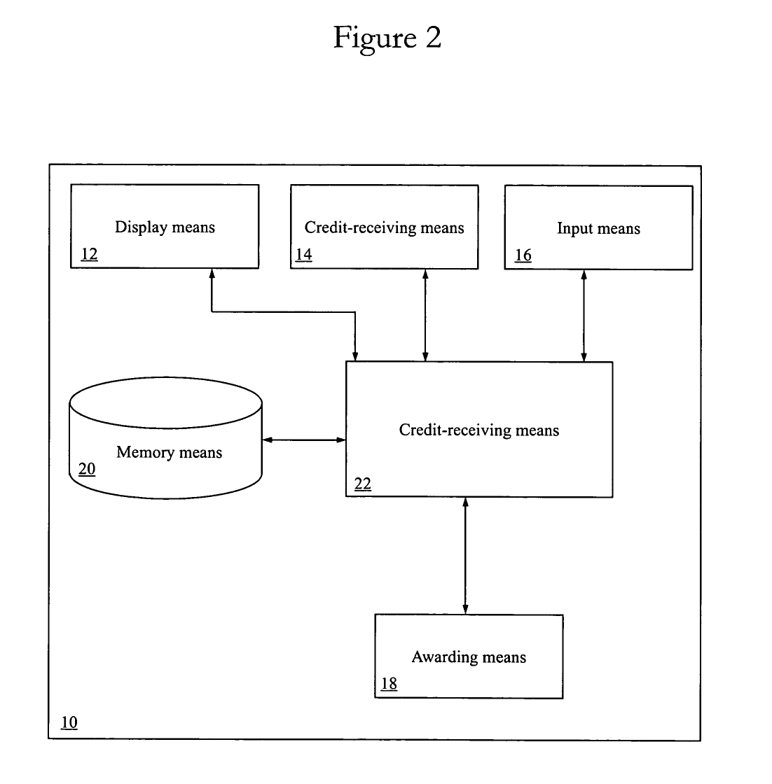

The present invention is preferably carried out on a gaming machine, as illustrated in FIGS. 1 and 2. Said gaming machine 10 comprises display means 12, such as a video screen, an LCD screen or mechanical reels; credit-receiving means 14 such as a card reader, or a coin and/or bill acceptor; input means 16, such as buttons, levers or a touch screen; awarding means 18, such as a ticket printer, a card reader or a hopper; memory means 20; a game controller means 22; determination means 24, evaluation means 26 and replacement means 28.

The invention may also be applied in a computer program, or at a remote terminal, the game information (not shown) being distributed via a network, such as linked machines or the Internet, or broadcasted using an electrical or electro-magnetic signal.

The preferred embodiment of the current invention is a slot machine but can easily be applied to a card game, or any instant game like bingo, lotto or keno.

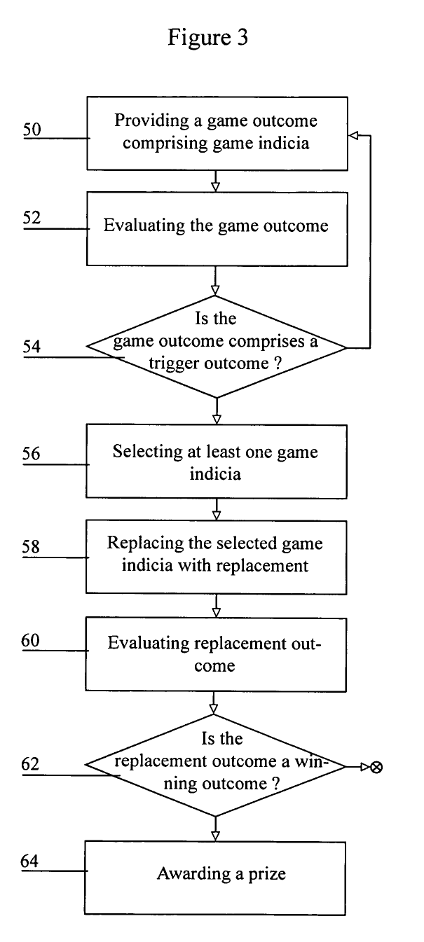

FIG. 3 illustrates the steps of a simple embodiment of the present invention, wherein the game indicia are replaced just once. After a game outcome comprising game indicia is provided (step 50) and evaluated (step 52), it is determined whether or not this game outcome comprises a triggering outcome (step 54). If the determination is positive, at least one game indicium is selected (step 56) (accordingly to feature rules, randomly or by the player) and replaced by replacement game indicia (step 58). The replacement outcome is determined (step 60), evaluated (step 62), and if it is determined that this replacement outcome corresponds to a winning outcome (step 64), a prize is awarded (step 66).

According to this embodiment, the game indicia come from a first set of indicia, while the replacement game indicia come from a second set of indicia. These sets may be different from each other. For example in a line game, the game indicia are symbols as usually used in such a game, while the replacement game indicia are bonus values.

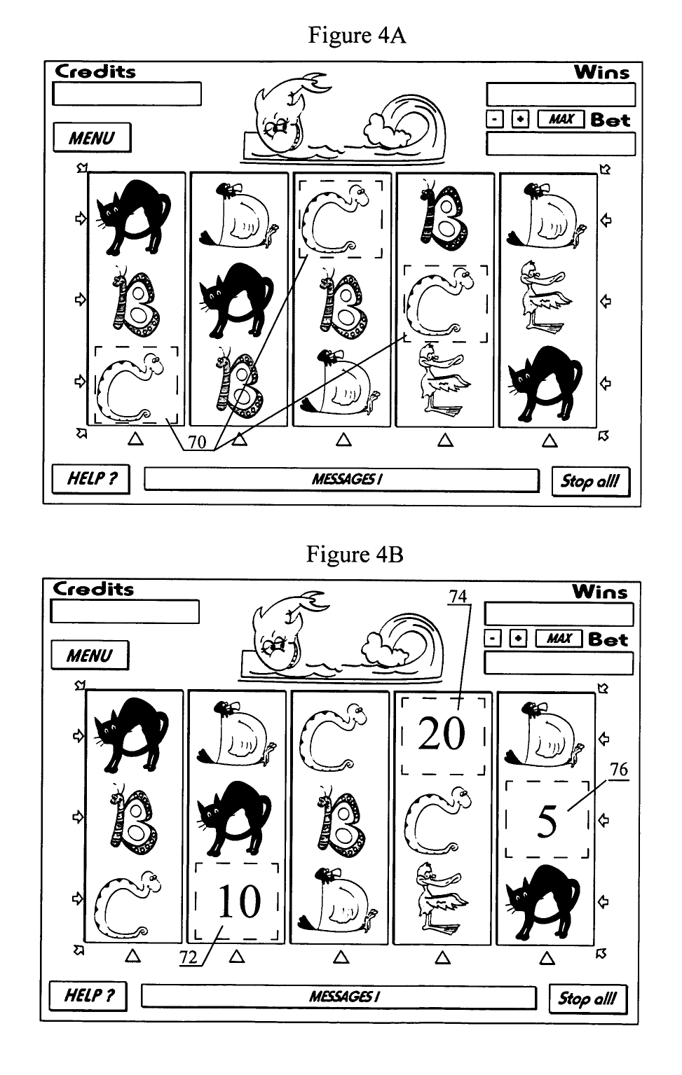

FIGS. 4a and 4b show screen shots, before and after replacement. In this example, having three “C” symbols 70 on the screen is the triggering outcome. The symbols participating in the triggering outcome are selected according to game rules, and are replaced during the replacement feature. Accordingly, the participating symbols are replaced by bonus values, respectively ten (10) credits 72, twenty (20) credits 74 and five (5) credits 76, for a total of thirty-five (35) credits.

The first and second sets of indicia may also be identical. In that case, the replacement game indicia may be used in one of three manners: a) they can be used in collaboration with the non-replaced game indicia to create a replacement outcome; b) they can be used in collaboration with each other without the participation of the non-replaced game indicia to create a replacement outcome; or c) they can be used individually to each create a replacement outcome.

The replacement outcome is evaluated according to feature game rules, which may be at least partially identical to or totally different from the game rules. If the replacement outcome is created by the collaboration of the replacement game indicia and the game indicia, the feature rules should be at least in part different from the game rules.

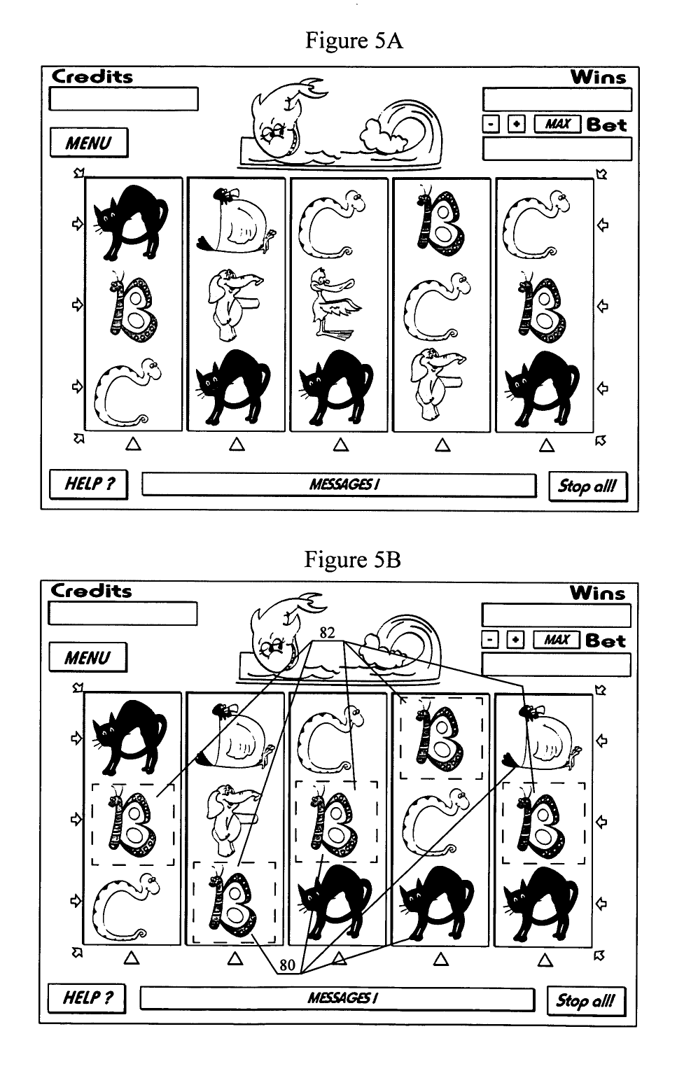

FIGS. 5a and 5b illustrate an embodiment wherein the replacement outcome is created by the collaboration of the replacement game indicia and the game indicia with the replacement rules being different from the game rules. FIG. 5a shows, before the replacement feature is triggered, a screen shot of a game wherein game rules award a prize for lines formed of three (3), four (4) and five (5) identical symbols and wherein the triggering outcome is an “E” symbol in the center position. On the other hand, FIG. 5b illustrates the same game after the replacement feature has taken place. The replacement rules demand for a scatter-type evaluation wherein a prize is awarded for gathering four (4) and more identical symbols and reward also lines of four (4) and five (5) identical symbols. The replacement-feature participating game indicia are randomly selected among all game indicia on the screen. In this example, four (4) game indicia 80 participate in the replacement feature and the player is not awarded a prize for the game outcome, but is awarded the prize associated with gathering five (5) identical symbols 82.

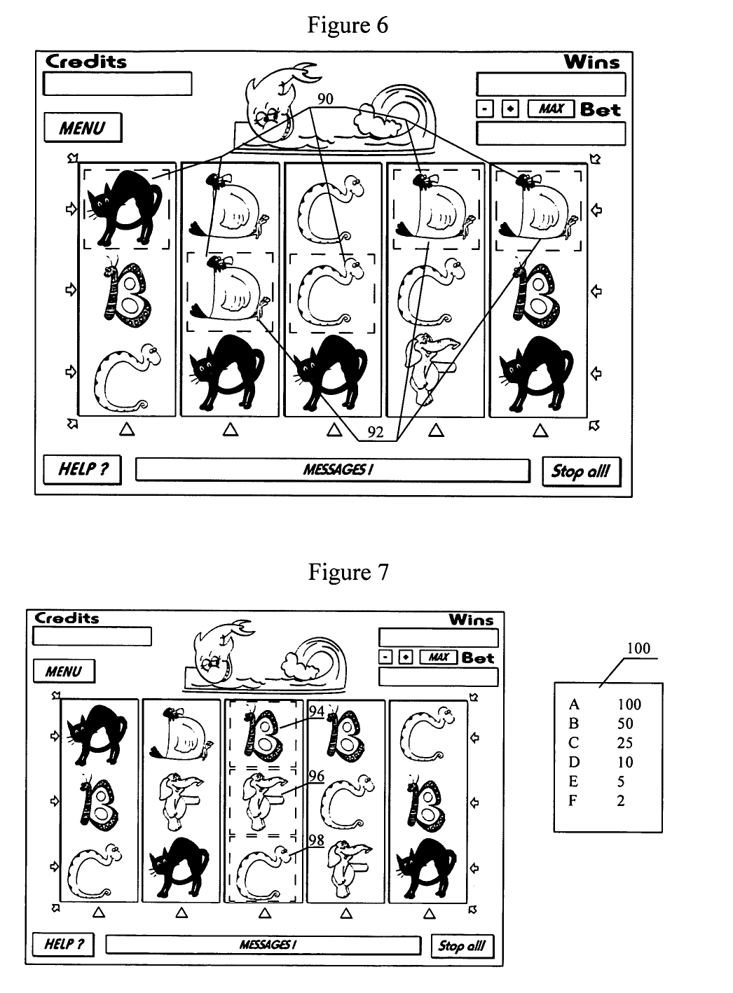

FIG. 6 illustrates an embodiment wherein the replacement outcome is created by the collaboration of the replacement game indicia without the participation of the non-replaced game indicia. FIG. 6 is a screen shot of the game illustrated on FIG. 5a after the replacement feature has taken place. The replacement rules demand a scatter-type evaluation of the replacement game indicia. In this example, the player is invited to select five (5) game indicia 90 which are replaced during the replacement feature. The player receives a prize for each symbol appearing more than twice on the screen. In the present example, the player receives a prize for having three (3) gaming indicia bearing a “D” value 92.

FIG. 7 illustrates an embodiment wherein each replacement game indicium forms a replacement outcome. In this example, the triggering outcome is an “E” symbol on the screen, and all indicia appearing on the “reel” bearing the triggering outcome participate in the replacement feature. The game outcome before the replacement feature can be found on FIG. 5a. Since each replacement game indicium is treated as a replacement outcome, three replacement outcomes are evaluated and the player is awarded up to three prizes. In this example, the player receives prizes of fifty (50) credits 94, two (2) credits 96, and twenty-five (25) credits 98 for a total of seventy-seven (77) credits, according to feature rules and the feature pay table 100.

The replacement feature is also characterized in that each participating indicium may be replaced more than once. To do so, a number of replacement game indicia is determined, a) according to game rules or b) randomly for all of the replacement-feature participating game indicia or c) randomly and individually for each of them. Accordingly, if it is determined that three (3) game indicia participate in the replacement feature and they should be replaced respectively by three (3), one (1) and one (1) replacement game indicia, the replacement feature would end after the first gaming indicia has been replaced three times, and the second and the third have been replaced once.

Another way to control the length of the replacement feature is to allow the replacement of the replacement-feature participating game indicia until a condition is met. This condition may, for example, be:

Accumulation of a randomly determined payout value: a prize value is randomly determined upon occurrence of the triggering outcome and the replacement feature awards the prize in at least one replacement. Ex. : The randomly determined prize has a value of thirty-five (35) credits and five indicia participate in the replacement feature. The replacement game indicia value are three (3), eight (8), five (5), six (6), and five (5). Since the total of these values is twenty-seven (27) and does not reach the predetermined prize value, at least one of the five participating game indicia is replaced a second time. Two game indicia are replaced a second time and award five (5) and three (3) credits.

Depletion of a predetermined or randomly determined number of replacements: a number of replacements is determined in advance or randomly determined upon occurrence of the triggering outcome. Each time a game indicia is replaced, the number of replacement is depleted until all the replacements are done. Ex.: Upon occurrence of the triggering outcome, it is randomly determined that there will be six (6) replacements during the feature. In this example, four (4) indicia are participating in the triggering event and these are the game indicia that are to be replaced. Each indicia are replaced independently, which means a sole game indicium may be replaced up to six (6).

All indicia bear a predetermined or randomly determined replacement game indicia value: a value is determined in advance or upon occurrence of the triggering outcome. As soon as a replacement game indicium bears the determined value, it freezes and cannot be replaced until the end of the feature. When all the participating replacement game indicia bear the determined value, the feature ends.

Accumulation of a predetermined or randomly determined number of occurrences of a certain replacement game indicia value: a replacement game indicia value is predetermined or randomly determined upon occurrence of the triggering outcome and is monitored during the replacement feature. An ending trigger, corresponding to a number of occurrences of the monitored replacement game indicia value is also predetermined or randomly determined upon occurrence of the triggering outcome. When a replacement game indicia bears the determined value, a counter is updated to reflect this occurrence. Upon occurrence of the ending trigger, when the counter reaches the determined number of occurrences, the replacement feature ends.

A predetermined or randomly determined length of time has elapsed: upon occurrence of the triggering outcome, a length of time is determined (if there is no predetermined length of time) and a time meter starts. The participating game outcomes are replaced, independently from each other, until the time meter indicates the predetermined or randomly determined length of time, upon which the feature ends.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium, processor-readable memory or an electrical or electro-magnetic signal.

The embodiments of the invention described above are intended to be exemplary only. The scope of the invention is therefore intended to be limited solely by the scope of the appended claims.

1. A method of playing a game comprising:
providing a game outcome comprising a plurality of game indicia selected from a first set of game indicia;
evaluating said game outcome according to game rules;
determining whether said game outcome comprises a triggering outcome;
upon occurrence of a positive triggering outcome determination, replacing one or more game indicia of the game outcome with one or more replacement game indicia selected from a second set of game indicia;
determining at least one replacement outcome based at least in part on said one or more replacement game indicia; and
evaluating each of said at least one replacement outcome according to replacement game rules, wherein at least one of a) said first set of game indicia and said second set of game indicia; and b) said game rules and said replacement game rules, are not identical.

2. The method of claim 1, wherein the step of replacing one or more game indicia is repeated at least once.

3. The method of claim 2, wherein the step of replacing one or more game indicia comprises determining a number of replacement game indicia for a replacement-feature participating game indicium.

4. The method of claim 2, wherein the step of replacing one or more game indicia comprises determining a number of replacement game indicia common for all replacement-feature participating game indicia.

5. The method of claim 2, wherein the step of replacing one or more indicia is repeated until a condition is met.

6. The method of claim 5, wherein said condition comprises at least one of: a) a randomly determined prize value is accumulated; b) a predetermined or randomly determined total number of replacement game indicia is depleted; c) all replacement game indicia bear a predetermined or randomly determined replacement game indicia value; d) a certain replacement game indicia value has occurred a predetermined or randomly determined number of times; and e) a predetermined or randomly determined length of time has elapsed.

7. The method of claim 1, wherein the step of replacing game indicia comprises randomly selecting replacement-feature participating game indicia among said game indicia forming said game outcome.

8. The method of claim 1, wherein the step of replacing game indicia comprises receiving a player selection of replacement-feature participating game indicia among said game indicia forming said game outcome.

9. The method of claim 1, wherein the step of replacing game indicia comprises selecting replacement-feature participating game indicia among said game indicia forming said game outcome according to feature rules.

10. The method of claim 1, wherein the step of evaluating the game outcome comprises awarding a prize.

11. The method of claim 1, wherein the step of evaluating the at least one replacement outcome comprises awarding a prize.

12. The method of claim 1, wherein said game indicia comprise at least one of symbols, cards, numbers, and letters.

13. A game apparatus comprising:
display means to display a game outcome comprising a plurality of game indicia selected from a first set of game indicia;
evaluation means to evaluate the game outcome according to game rules and at least one replacement outcome according to replacement game rules;
determination means to determine whether said game outcome comprises a triggering outcome, and determining at least one replacement outcome based at least in part on one or more replacement game indicia; and
replacement means to replace said game indicia with said one or more replacement game indicia selected from a second set of game indicia,
wherein at least one of a) said first set of game indicia and said second set of game indicia; and b) said game rules and said replacement game rules, are not identical.

14. A computer program embodied on a computer readable medium or in processor-readable memory having codes adapted to:
provide a game outcome comprising a plurality of game indicia selected from a first set of game indicia;
evaluate said game outcome according to game rules;
determine whether said game outcome comprises a triggering outcome;
upon occurrence of a positive triggering outcome determination, replace one or more game indicia of the game outcome with one or more replacement game indicia selected from a second set of game indicia;
determine at least one replacement outcome based at least in part on said one or more replacement game indicia; and
evaluate each of said at least one replacement outcome according to replacement game rules, wherein at least one of a) said first set of game indicia and said second set of game indicia; and b) said game rules and said replacement game rules, are not identical.

15. A computer program carried on an electrical or electro-magnetic carrier signal having codes adapted to:
provide a game outcome comprising a plurality of game indicia selected from a first set of game indicia;
evaluate said game outcome according to game rules;
determine whether said game outcome comprises a triggering outcome;
upon occurrence of a positive triggering outcome determination, replace one or more game indicia of the game outcome with one or more replacement game indicia selected from a second set of game indicia;
determine at least one replacement outcome based at least in part on said one or more replacement game indicia; and
evaluate each of said at least one replacement outcome according to replacement game rules,
wherein at least one of a) said first set of game indicia and said second set of game indicia; and b) said game rules and said replacement game rules, are not identical.
